(19) United States
(12) Patent Application Publication
(10) Pub. No.: US 2006/0256278 A1
(43) Pub. Date: Nov. 16, 2006

(54) Eyewear Frame and Storage Mechanism

(76) Inventor: James Minoru Amioka, Plattsburgh, NY (US)

Correspondence Address: DELAIN LAW OFFICE, PLLC, 400 CLIFTON CORPORATE PARKWAY, CLIFTON PARK, NY, 12065, US

(21) Appl. No.: 10/908,505

(22) Filed: May 15, 2005

(51) Int. Cl. G02C 5/00

(52) U.S. Cl. 351/41

(57) ABSTRACT

The present invention improves existing eyewear frames to provide a secure and convenient means for storage and transport of eyewear when it is not being worn on the face. The invention removes any need for a case or container for the eyewear. The eyewear frames contain lenses, which may be, for example, prescription lenses, reading lenses, darkened lenses as in sunglasses, protective lenses, or a military lens such as night-vision goggles. When not in use as eyeglasses, the frames can be folded into a band for the wrist, arm or ankle. An optional reminder pad may be attached to the eyewear frames for the person using the frames to write short reminders to him- or herself. The reminder pad may be made of paper, of washable plastic, or of any other suitable writing surface material.

### BACKGROUND OF THE INVENTION

1. Field of the Invention

The field of the invention is eyewear, specifically frames for eyewear.

2. Description of Related Art

Frames for eyewear are well known in the art. Existing frames generally comprise a rigid or semirigid frame that fits over the eyes for holding a lens or a pair of lenses upon the face in front of the eyes, held in place upon the face by rigid or semi-rigid earpieces that fit behind the ears to hold the eyewear on the face. Alternatively, the eyewear may have a band that encircles the head and attaches to the eyewear to hold the eyewear in place. The eyewear also generally has a rigid piece that crosses the nose between the means for holding the lenses. If the eyewear has rigid earpieces, the earpieces generally fold across the lenses for storage.

Another alternative embodiment of known eyewear frames is the so-called “pince-nez” frames, which do not have earpieces, but the nosepiece is flexible and when worn, the pince-nez is held in place by friction and compression as the nosepiece causes the eyewear to pinch the bridge of the wearer's nose to hold the attached lenses before the wearer's eyes.

Also known in the art is the so-called “monocle,” a single lens that is held In place before the eye by compressing the edges of the lens between the top and bottom of the human eye socket.

The existing art provides means for storing eyewear when it is not being worn on the face comprising a case or container for the eyewear. The eyeglasses case or container is cumbersome to carry, requiring a pocket or a satchel or purse if the wearer chooses not to carry the case in his or her hand. This can be inconvenient at times when the wearer either does not have a pocket or chooses not to carry a purse or satchel. Some eyeglasses wearers address this inconvenience by placing their eyeglasses on top of their heads, from whence the eyeglasses can easily fall and become lost or broken. Others wear a necklace or pin that they hook one earpiece through or around, where the eyeglasses can get in the way of various activities such as swimming, skiing, or other active sports or activities. Monocle wearers may have a strap or necklace attached to the lens which they wear around the neck or attached to a jacket, shirt or blouse button.

Lenses on pivot joints are also known. The inventor has seen a timekeeping watch in the marketplace which has one or more lenses pivotally attached to the watch's rim. The lens or lenses pivot up to form a binocular or telescope.

The need exists in the art for a convenient and secure storage system for eyeglasses when they are not being worn.

### BRIEF SUMMARY OF THE INVENTION

The present invention provides eyewear frames that can be folded into a convenient means for storage and transport when the eyewear is not being worn on the face. The invention removes the need for a case or container for the eyewear. The eyewear frames contain eyeglass lenses, which may be, for example, prescription lenses, reading lenses, darkened lenses for sunglasses, protective lenses, or a military lens such as night-vision goggles. When not in use as eyeglasses, the frames can be folded or bent into a band for the wrist, arm or ankle. A lens may optionally pivot out to allow the individual to use the lens to view something without removing the eyeglasses and converting them from the band form to the traditional eyeglasses form. A small optional memo pad may be attached to the frame for the person using the frame to write short reminders to him- or herself. The memo pad may be made of paper, of washable plastic, or of any other suitable writing surface material.

### BRIEF DESCRIPTION OF THE DRAWINGS

FIG. 1 shows the eyeglass frames with lenses attached, in the form of a band, armband or anklet.

FIG. 2 shows the band form of the eyeglass frames opening out to form traditional eyeglasses.

FIG. 3 shows the fully expanded eyeglasses.

FIG. 4 shows the eyeglasses in band form with a lens extended for reading or other viewing with the eyeglasses in band form.

FIG. 5 shows the earpieces to the eyeglasses comprising a stiffer material and hinged to allow the earpieces to be locked into place in either the band or the eyeglasses configuration.

FIG. 6 shows the eyeglasses in band form, clipped together at the nosepiece.

FIG. 7 shows the eyeglasses in expanded form with blocks to prevent the earpieces from moving too far inward.

FIG. 8 shows the eyeglasses in band form, clipped together at the end of each earpiece.

FIG. 9 shows the eyeglasses in expanded form.

FIG. 10 shows the eyeglasses in band form with a sliding mechanism.

FIG. 11 shows the eyeglasses in expanded form, held together with a clip on the nosepiece.

FIG. 12 shows a protective shell for the lenses to the eyewear for use when the eyewear is worn in band form on the arm, leg, wrist, or ankle. When the eyewear is worn in eyeglasses form, the protective shell can remain on the wearer's extremity. The protective shell can be manufactured in any color to meet the wearer's fashion sense.

### DETAILED DESCRIPTION OF THE INVENTION

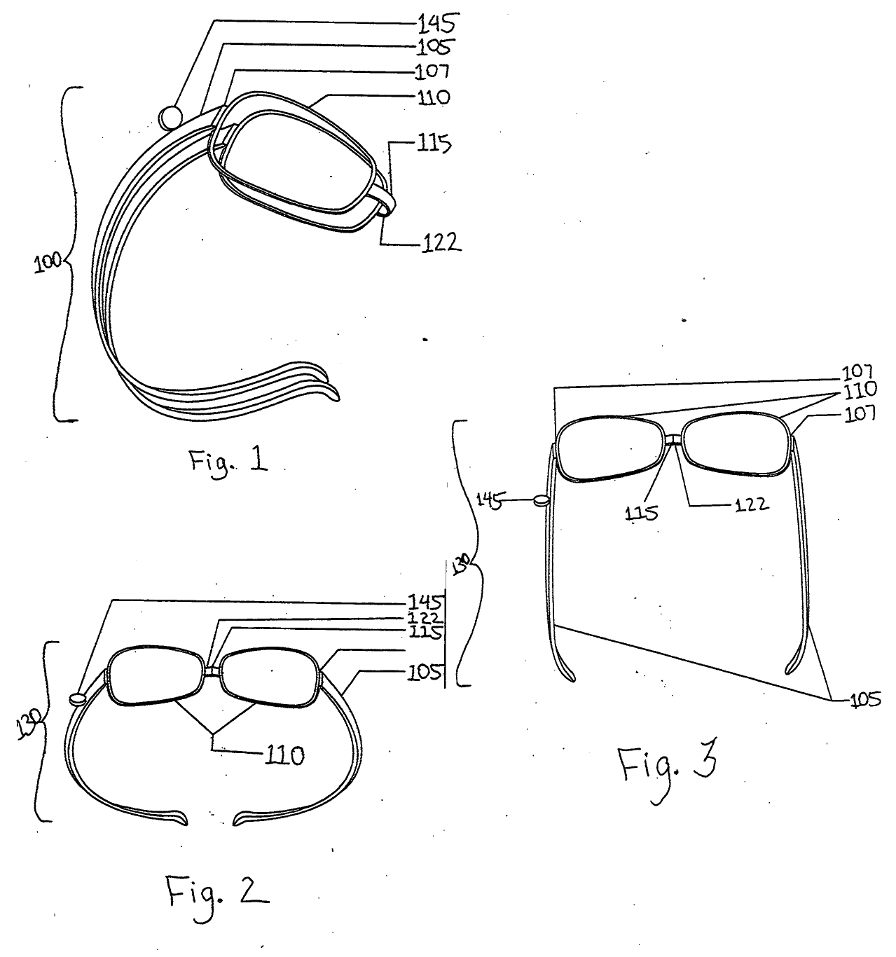

Referring now to FIG. 1, eyewear 100 is shown folded in the band configuration. The earpieces 105 are next to each other, and the earpieces 105 are hingedly attached 107 to a pair of lenses 110. The eyewear lenses 110 are attached at a pivot 115 which also serves as the nosepiece 122. Earpieces 105 made of bendable material capable of being reconfigured between earpieces and a band many times without fatigue or breaking are attached to each lens 110 on the side opposite the pivot 115.

In the band configuration, the lenses 110 are closely adjacent to each other, and the earpieces 105 are curled to wrap around the wearer's wrist, arm, or ankle, with the lenses 110 forming a jewel on the band. The band is comprised of materials flexible enough to accommodate different sized wrists, arms, legs, and ankles. To open the band to form eyeglasses, the earpieces 105 are pulled to separate them from each other. The lenses 110, which are attached with hinges 117 to the earpieces 105, are simultaneously pulled apart by the pulling action on the earpieces 105 until the lenses 110 are adjacent to each other across a nosepiece 122 in the form of eyeglasses 130. The flexible earpieces 105 can then be wrapped around the wearer's ears.

The lenses 110 used in the eyewear 100 may be of any type, including but not limited to prescription lenses, sunglasses, reading glasses, protective lenses, or lenses such as night vision lenses.

There is an optional small lamp 145 attached to the eyewear 100 on the earpiece 105.

Referring now to FIG. 2, eyewear 100 is shown expanded into eyeglasses 130, with two earpieces 105, two lenses 110 configured to rest before a pair of human eyes, and a nosepiece 122. The nosepiece 122, which is comprised of either a flexible material or of an inflexible material with a joint 115 in the center of the nosepiece 122, also serves as a pivot 115 when the eyewear 100 is in the band configuration. A small optional light 145 is attached to an earpiece 105.

Referring now to FIG. 3, the eyewear 100 is shown fully extended into the configuration of eyeglasses 130. A small optional light 145 is attached to an earpiece 105.

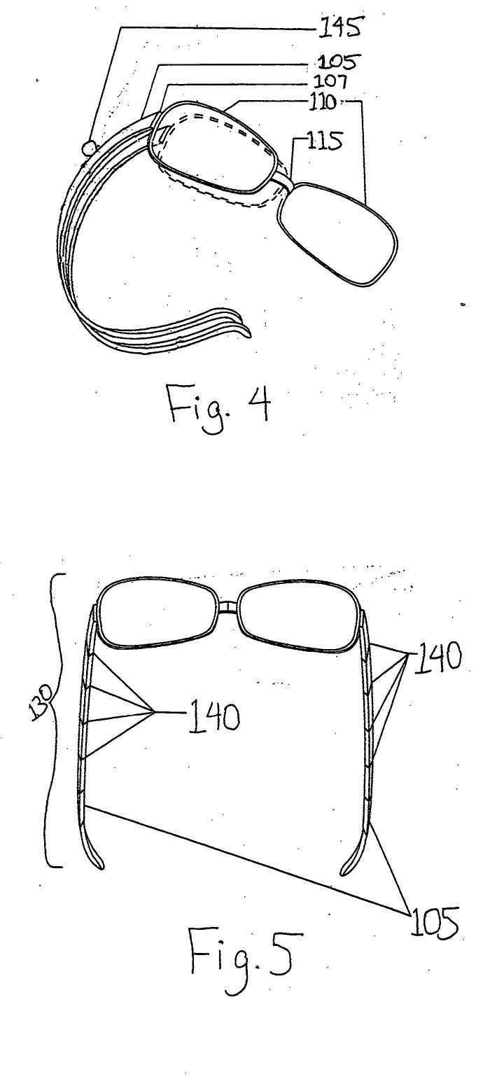

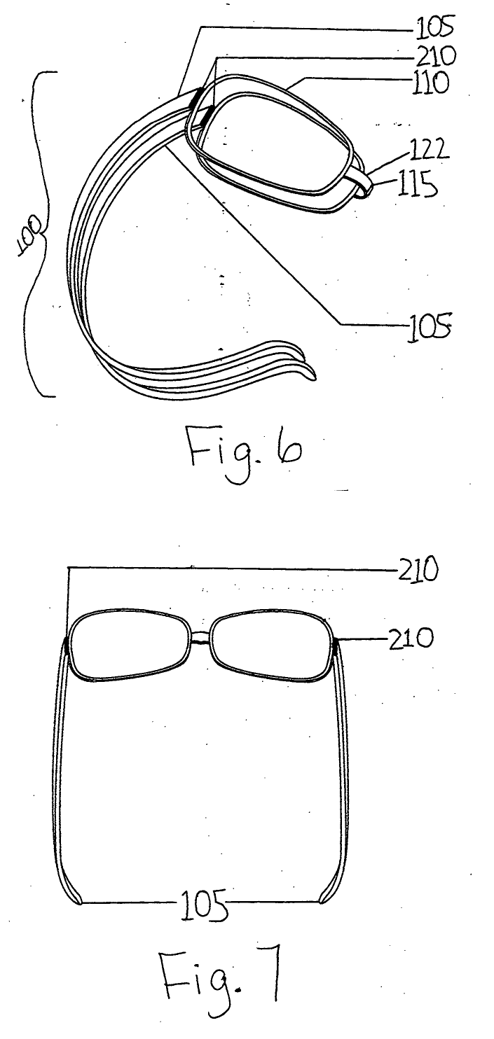

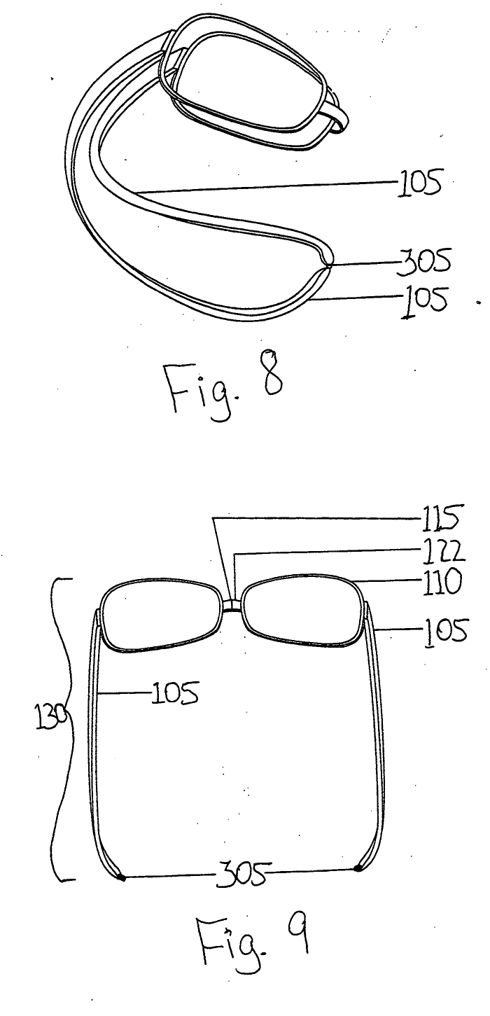

Referring now to FIG. 4, the eyewear 100, shown in the band configuration, may optionally have a joint 115 that allows one lens 110 to rotate or pivot such that the one lens 110 can be positioned, while the eyewear 100 is in the band configuration, in a way that the wearer can use the one lens 110 to look through for functions such as reading small print, magnification or other functions. The eyewear 100 may also optionally have a set of clips 125 for holding a small optional memo pad 135. The memo pad 135 may be made of whiteboard material, paper, blackboard material, or any other suitable writing surface. The memo pad 135 may be washable.

Referring now to FIG. 5, the eyewear 100 is shown in the eyeglasses configuration 130. The earpieces 105 in this embodiment are made of a stiff plastic or metal material, and comprise one or a plurality of links 140 to enable the earpieces to be bent between the eyeglasses configuration and the band configuration with a reliable return to the other configuration each time the eyewear is converted between eyeglasses and a band.

Referring now to FIG. 6, eyewear 100 is shown in a band configuration, with earpieces 105 next to each other, lenses 110 next to each other, and a pivot 115 that converts into a nosepiece 122. An optional block 210 prevents the earpieces 105 from moving too far inward.

Referring now to FIG. 7, eyeglasses 130 are shown with the optional block 210 preventing the earpieces 105 from moving too far inward.

Referring now to FIG. 8, the eyewear 100 is shown in a band configuration wherein the earpieces 105 are separated and surround the wearer's arm, wrist, ankle or leg. The earpieces 105 are joined at the ear end by a clasp 305, such as a jewelry clasp.

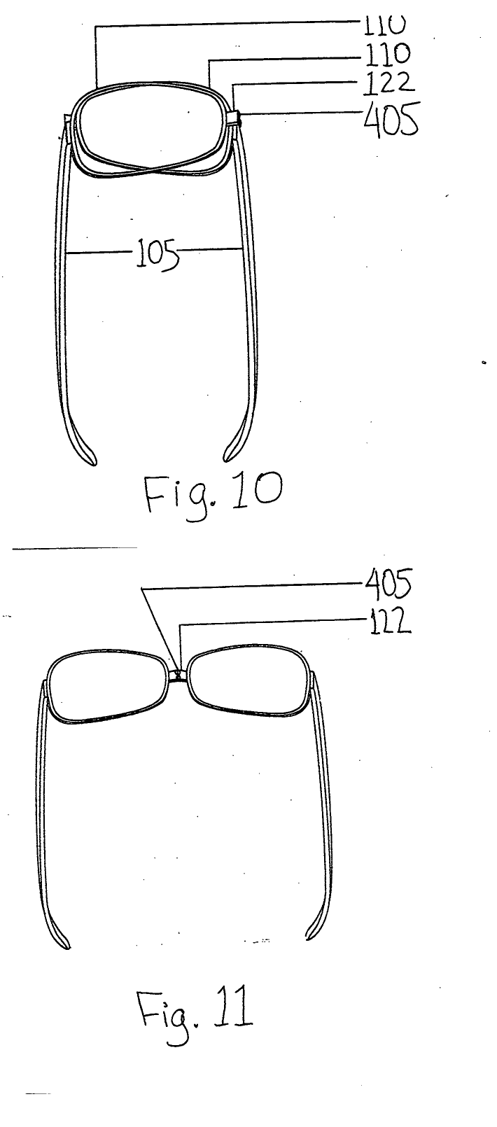

Referring now to FIG. 9, eyeglasses 130 are shown fully expanded. The lenses 110 are in the configuration that is normal for eyeglasses in general, the pivot 115 forms the nosepiece 122, and the earpieces 105 are extended to fit the wearer's head. The clasp 305 is disengaged at the end of each earpiece 105.

Referring now to FIG. 10, the eyewear 100 is shown halfway between the band configuration and the fully extended eyeglasses configuration. The nosepiece 122 halves are detached and the lenses 110 move laterally across one another to attach to the opposite lens's 110 earpiece 105 with a clasp 405.

Referring now to FIG. 11, the eyeglasses 130 are shown fully expanded. The clasp 405 is used to hold the nosepiece 122 together as a nosepiece for eyewear.

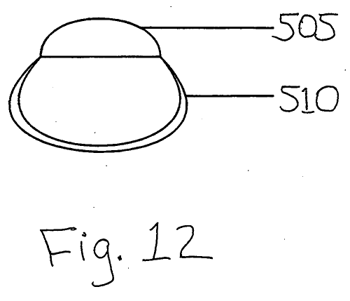

Referring now to FIG. 12, an optional cover 505 is shown. The cover 505 can be used to protect the lenses 110 (not shown) from damage when the eyewear 100 (not shown) is being worn in the band configuration. The cover 505 is formed from a durable material that can be formed to cover the lenses 110 (not shown). The cover 505 has a cover band 510 formed of a flexible material that can be used to hold the cover 505 on the arm when the cover 505 is not being used to protect the lenses 110 (not shown).

For any embodiment of this invention, the lenses 110 may be of any type that can be used in standard eyewear, including but not limited to reading lenses, darkened lenses for sunglasses, prescription lenses, plate glass or optically inert plastic lenses, protective lenses, and night vision lenses, or any combination of lens types (for example, prescription sunglasses).

While a preferred embodiment is shown and described herein, it should be understood that the present disclosure is made by way of example only and that variations in the described device and its uses are possible within the scope of this disclosure without departing from the subject matter coming within the scope of claims to be examined, and a reasonable equivalency thereof, which I regard as my invention.

I claim:

1. An eyewear frame comprising:
a frame to hold a pair of lenses over human eyes, said frame comprising a right side, a left side, an inner side, said inner side being located adjacent to said human eyes when worn, an outer side, said outer side being located opposite said inner side, a right lens holder, a left lens holder, each of said right and left lens holders being capable of holding a lens of any type that can be used in eyewear, and a nosepiece, said nosepiece being connectedly located between said right and left lens holders and connectedly divided into two substantially equal halves, a right half and a left half;
two earpieces, one earpiece being hingedly attached to each of said right and left sides of said frame, each of said earpieces comprising a frame end, an earpiece midsection, and an ear end; and
said frames and earpieces having a construction such that said frames and earpieces together can be configured either as eyeglasses or as a band to form a band, anklet, armband, legband, at the convenience of a person using said eyewear.

2. The eyewear frame of claim 1 further comprising said construction comprising said earpieces being comprised of a flexible material, said flexible material being capable of being repeatedly bent to form either said earpieces or said band without breaking.

3. The eyewear of claim 1 further comprising said lenses having an attachment to said nosepiece, said attachment being selected from the group consisting of rotating and pivoting, whereby said attachment enables said lenses to rotate or pivot around said nosepiece to form said band.

4. The eyewear frame of claim 1 further comprising said nosepiece having a clasp which enables said right and left sides of said eyeglass frames to be detached and reconnected.

5. The eyewear frame of claim 4 further comprising said lenses, when said nosepiece is detached, acting to form said band by fitting one lens on top of the other and attaching said nosepiece of each side to said other side's earpiece with a clasp or clamp.

6. The eyewear frame of claim 1 further comprising one of said lenses being mounted on a hinge of a type selected from the group consisting of rotating and pivoting, such that said lens can be used for viewing when said eyewear frame is configured as a band.

7. The eyewear frame of claim 1 wherein said nosepiece is comprised of a flexible material, allowing said nosepiece to bend while forming said band.

8. The eyewear frame of claim 1 wherein said earpieces are comprised of a nonflexible material, said earpieces being comprised of links rendering said earpieces capable of bending between said band configuration and said eyeglasses configuration, said material itself providing a blocker to prevent said earpiece from bending out of the proper shape for said eyeglasses or said band, said band being flexible enough to accommodate different wrist, arm, leg or ankle sizes.

9. The eyewear frame of claim 1 further comprising said band being formed by a clasp upon said nosepiece being used to hold said lenses in place when said eyewear is configured in the form of a circular band.

10. The eyewear frame of claim 1 further comprising said band being formed by bending said earpieces together and clasping said ear ends of said earpieces to said eyewear frame at a point at which said eyewear frame holds said lenses.

11. The eyewear frame of claim 1 further comprising said band being formed by folding said earpieces next to each other.

12. The eyewear frame of claim 11 further comprising said band being formed by clasping said ear ends of said earpieces together with a clasp substantially similar to a jewelry clasp.

13. The eyewear frame of claim 1 further comprising said band being formed by each of said earpieces forming substantially one-half of a circle, joined together at said ear end of each of said earpieces with a clasp substantially similar to a jewelry clasp.

14. The eyewear frame of claim 1 further comprising said frame being adapted to hold a small memo pad, said memo pad being comprised of paper, plastic which may be washable, whiteboard material, blackboard material, or other suitable writing surface.

15. The eyewear frame of claim 14 further comprising said frame holds a small light for reading said memo pad.

16. The eyewear frame of claim 14 further comprising said memo pad being held in place by a plurality of clips upon said frame, said clips being optionally removable.

17. The eyewear frame of claim 1 further comprising a blocker piece which prevents said earpieces from overextending.

18. The eyewear frame of claim 1 further comprising a detached cover fitting over said lenses when said eyewear frame is in said band configuration.

19. The eyewear frame of claim 20 further comprising said detached cover having a flexible cover band capable of holding said detached cover upon a wearer's wrist, arm, leg, or ankle when said cover is not being used to protect said lenses.

20. An eyewear frame comprising:
a frame to hold a pair of lenses over human eyes, said frame comprising a right side, a left side, an inner side, said inner side being located adjacent to said human eyes when worn, an outer side, said outer side being located opposite said inner side, a right lens holder, a left lens holder, each of said right and left lens holders being capable of holding a lens of any type that can be used in eyewear;
two earpieces, one earpiece being hingedly attached to each of said right and left sides of said frame, each of said earpieces comprising a frame end, an earpiece midsection, and an ear end and being comprised of a nonbendable material and comprising a series of links or hinges and each earpiece being prevented from overextension by a blocker made of a solid material inserted in a hinge between said earpiece and said frame;
said frames and said earpieces having a construction such that said frames and earpieces together can be configured either as eyeglasses or as a band to form a band, anklet, armband, legband, at the convenience of a person using said eyewear;
a nosepiece, said nosepiece being connectedly located between said right and left lens holders and connectedly divided into two substantially equal halves, a right half and a left half, said right and left halves being disconnected to form said band, said nosepiece right and left halves being held together by a clasp;
a pair of lenses attached to each half of said nosepiece, said lenses operating to cover a wearer's eyes when the eyewear is configured as eyeglasses, said right half nosepiece connecting to said frame end of a left side earpiece and said left half nosepiece connecting to said frame end of a right side earpiece when said eyewear is in said band configuration.

21. The eyewear frame of claim 20 further comprising one of said lenses being mounted on a hinge of a type selected from the group consisting of rotating and pivoting, such that said lens can be used for viewing when said eyewear frame is configured as a band.

22. The eyewear frame of claim 20 wherein said nosepiece is comprised of a flexible material, allowing said nosepiece to bend to form said band configuration.

23. The eyewear frame of claim 20 further comprising said band being formed by bending said earpieces together and clasping said ear ends of said earpieces to said eyewear frame at a point at which said eyewear frame holds said lenses.

24. The eyewear frame of claim 20 further comprising said band being formed by folding said earpieces next to each other.

25. The eyewear frame of claim 20 further comprising said band being formed by clasping said ear ends of said earpieces together with a clasp substantially similar to a jewelry clasp.

26. The eyewear frame of claim 20 further comprising said band being formed by each of said earpieces forming substantially one-half of a circle, joined together at said ear end of each of said earpieces with a clasp substantially similar to a jewelry clasp.

27. The eyewear frame of claim 20 further comprising said frame being adapted to hold a small memo pad, said memo pad being comprised of paper, plastic which may be washable, whiteboard material, blackboard material, or other suitable writing surface.

28. The eyewear frame of claim 27 further comprising said frame holds a small light for reading said memo pad.

29. The eyewear frame of claim 20 further comprising a detached cover fitting over said lenses when said eyewear frame is in said band configuration.

30. The eyewear frame of claim 29 further comprising said detached cover having a flexible cover band capable of holding said detached cover upon a wearer's wrist, arm, leg, or ankle when said cover is not being used to protect said lenses.

31. An eyewear frame comprising:
a frame to hold a pair of lenses over human eyes, said frame comprising a right side, a left side, an inner side, said inner side being located adjacent to said human eyes when worn, an outer side, said outer side being located opposite said inner side, a right lens holder, a left lens holder, each of said right and left lens holders being capable of holding a lens of any type that can be used in eyewear, and a nosepiece, said nosepiece being connectedly located between said right and left lens holders and connectedly divided into two substantially equal halves, a right half and a left half;
two earpieces comprised of a bendable material such as can be bent and returned to its original shape many times without breaking, one earpiece being hingedly attached to each of said right and left sides of said frame, each of said earpieces comprising a frame end, an earpiece midsection, and an ear end, said earpieces being blocked from overextension by a solid block affixed to said hinge between said earpiece and said frame;
a construction of said frame and earpieces such that said frame and earpieces together can be configured either as eyeglasses or as a band to form a band, anklet, armband, legband, at the convenience of a person using said eyewear, said band being formed by said earpieces bending together and clasping the ear ends of said earpieces to said lens holders;
a pair of lenses of any type that can be used in eyewear within said lens holders, one of said lenses mounted such that said lens can be rotated or pivoted out when said eyewear is in said band configuration;
a small memo pad optionally detachably attached to said eyewear frame, said memo pad comprising paper, whiteboard material, blackboard material, or washable plastic;
a plurality of optionally removable clips for holding said small memo pad to said eyewear frame; and
a small light optionally detachably attached to said eyewear frame for reading said memo pad.

32. The eyewear of claim 31 further comprising said lenses having an attachment to said nosepiece, said attachment being selected from the group consisting of rotating and pivoting, whereby said attachment enables said lenses to rotate or pivot around said nosepiece to form said band.

33. The eyewear frame of claim 31 further comprising said nosepiece having a clasp which enables said right and left sides of said eyeglass frames to be detached and reconnected.

34. The eyewear frame of claim 33 further comprising said lenses, when said nosepiece is detached, acting to form said band by fitting one lens on top of the other and attaching said nosepiece of each side to said other side's earpiece.

35. The eyewear frame of claim 31 wherein said nosepiece is comprised of a flexible material, allowing said nosepiece to bend to form said band configuration.

36. The eyewear frame of claim 31 wherein said earpieces are comprised of a nonflexible material, said earpieces being comprised of links rendering said earpieces capable of bending between said band configuration and said eyeglasses configuration, said material itself providing a blocker to prevent said earpiece from bending out of the proper shape for said eyeglasses or said band, said band being flexible enough to accommodate different wrist, arm, leg or ankle sizes.

37. The eyewear frame of claim 31 further comprising said band being formed by a clasp upon said nosepiece being used to hold said lenses in place when said eyewear is configured in the form of a circular band.

38. The eyewear frame of claim 31 further comprising said band being formed by folding said earpieces next to each other.

39. The eyewear frame of claim 51 further comprising said band being formed by clasping said ear ends of said earpieces together with a clasp substantially similar to a jewelry clasp.

40. The eyewear frame of claim 31 further comprising said band being formed by each of said earpieces forming substantially one-half of a circle, joined together at said ear end of each of said earpieces with a clasp substantially similar to a jewelry clasp.

41. The eyewear frame of claim 31 further comprising a detached cover fitting over said lenses when said eyewear frame is in said band configuration.

42. The eyewear frame of claim 41 further comprising said detached cover having a flexible cover band capable of holding said detached cover upon a wearer's wrist, arm, leg, or ankle when said cover is not being used to protect said lenses.
